(19) United States
(12) Patent Application Publication
(10) Pub. No.: US 2013/0173470 A1
(43) Pub. Date: Jul. 4, 2013

(54) METHODS AND SYSTEMS FOR USING A CO-LOCATED GROUP AS AN AUTHORIZATION MECHANISM

(71) Applicants: Frank Anthony Nuzzi, Austin, TX (US); James Brett Sowder, Austin, TX (US)

(72) Inventors: Frank Anthony Nuzzi, Austin, TX (US); James Brett Sowder, Austin, TX (US)

(73) Assignee: eBay Inc., San Jose, CA (US)

(21) Appl. No.: 13/546,401

(22) Filed: Jul. 11, 2012

Related U.S. Application Data
(63) Continuation of application No. 13/340,626, filed on Dec. 29, 2011.

(51) Int. Cl. G06F 21/00; G06Q 40/00

(52) U.S. Cl. 705/44; 726/4

(57) ABSTRACT

Systems and methods to enable a co-located group to be used as an authorization mechanism are discussed. For example, a method can include establishing a group account, receiving a request to access the group account, determining whether the requester is a group member, determining whether the requester is near an authorized location, and authorizing access to the group account. Authorizing access to the group account can be based on determining that the requester is a member and is within a pre-defined distance of an authorized location.

### CROSS-REFERENCE TO RELATED APPLICATION

This application is a Continuation of U.S. application Ser. No. 13/340,626, filed Dec. 29, 2011, which application is incorporated by reference herein in its entirety.

### TECHNICAL FIELD

This application relates generally to data processing within a network-based system operating over a distributed network, and more specifically to systems and methods for using a co-located group as an authorization mechanism.

### BACKGROUND

The ever increasing use of smart phones, such as the iPhone® (from Apple, Inc. of Cupertino Calif.), with data connections and location determination capabilities is slowly changing the way people interact, shop for products and services, and even manage accounts. Smart phones can provide users with nearly instant information regarding a wide range of information, such as product availability, friend locations, or pricing. For example, applications such as RedLaser™ (from eBay, Inc. of San Jose, Calif.) allow a smart phone user to scan a bar code and instantly check prices across online and local retail outlets. Smart phones also commonly include mechanisms, such as global positioning system (GPS) receivers, that allow the devices to constantly update location information. These technology changes are also driving changes in the way groups of people interact and exchange information.

### BRIEF DESCRIPTION OF THE DRAWINGS

Some embodiments are illustrated by way of example and not limitation in the figures of the accompanying drawings in which:

FIG. 1A is a block diagram depicting a system for using group membership in combination with location as an authorization mechanism, according to an example embodiment.

FIG. 1B is a block diagram depicting a system for using group membership in combination with location as a payment authorization mechanism, according to an example embodiment.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based system for using a co-located group as an authorization mechanism, according to an example embodiment.

FIG. 5 is a block diagram illustrating authorization modules, according to an example embodiment.

FIG. 6 is a flowchart illustrating a method of enabling a co-located group as an authorization mechanism, according to an example embodiment.

FIG. 7 is a flowchart illustrating a method of using group membership in combination with location information as an authorization mechanism, according to an example embodiment.

FIG. 8 is a flowchart illustrating a method of using group membership in combination with location information as a payment authorization mechanism, according to an example embodiment.

FIG. 9 is a diagrammatic representation of a machine in the example form of a computer system within which a set of instructions for causing the machine to perform any one or more of the methodologies discussed herein may be executed.

### DEFINITIONS

Location—For the purposes of this specification and the associated claims, the term “location” is used to refer to a geographic location, such as a longitude/latitude combination or a street address. The term location is also used within this specification in reference to a physical location associated with an event, such as a vacation destination.

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Context—For the purposes of this specification and the associated claims, the term “context” is used to refer to environmental inputs, such as location, time, and weather conditions, among others. The context generally refers to conditions describing an individual's (e.g., user's) environment and/or activities. For example, context information can include a user's location, direction of movement, current activity (e.g., working, driving, playing golf, shopping, etc.), current weather conditions, time of day, and time of year (e.g., season), among other things. In certain examples, context information about a user can also include past events, purchase history, or other historical data about the user.

### DETAILED DESCRIPTION

Example systems and methods for using a co-located group as an authorization mechanism are described. Also described are systems and methods for using group membership and user context, such as location, as an authorization mechanism. In some example embodiments, the systems and methods for using a co-located group as an authorization mechanism may enable a user to access to a group account on a social networking site or may enable access to a group payment account, among other things. In the following description, for purposes of explanation, numerous specific details are set forth in order to provide a thorough understanding of example embodiments. It will be evident, however, to one skilled in the art, that the present invention may be practiced without these specific details. It will also be evident that co-location group authentication is not limited to the examples provided and may include other scenarios not specifically discussed.

In accordance with an example embodiment, a network-based system can provide a platform to use a co-located group as an authentication mechanism. For example, a photo sharing site can include the ability to create a group event account that enables the group members to upload pictures whenever two or more of the group members are together (physically located in the same location, or within a distance defined within the authentication mechanism). In another example, the photo sharing site can include the ability for a group account to be configured with a membership list, a temporal limitation, and a location limitation controlling access to the account. For example, if a group of friends are going on a vacation together, the group photo account can be configured to allow uploads to the account during the time of the vacation (e.g., temporal limitation) and while a group member is in the vacation location (e.g., location limitation).

In accordance with another example embodiment, a network-based payment system can provide a platform to use a co-located group as an authentication mechanism. In this example, the network-based payment system can be used to host group payment accounts. The group payment accounts can include authorization rules such as membership lists, location limitations (e.g., target location), and/or temporal limitations (e.g., list of active dates). In an example, a group payment account can be setup for a group of friends or a family going on a vacation that wish to share expenses during the trip. Payments can be authorized against the group payment account based on validation of group membership and location, among other things. For example, a group account could be configured to enable payments within a theme park, up to an authorization limit, for users that are members of the group. In an example, the network-based payment system can communicate with group members via a mobile device. The mobile devices can provide identification and location information. In certain examples, the mobile devices can also be used to conduct the payment transactions with a merchant. For example, users of the network-based payment system can use a PayPal® mobile application (from PayPal, Inc. of San Jose Calif.) to process payments to participating merchants. In this example, the PayPal® payment authorization can include group account validation processes as discussed below.

### Example System

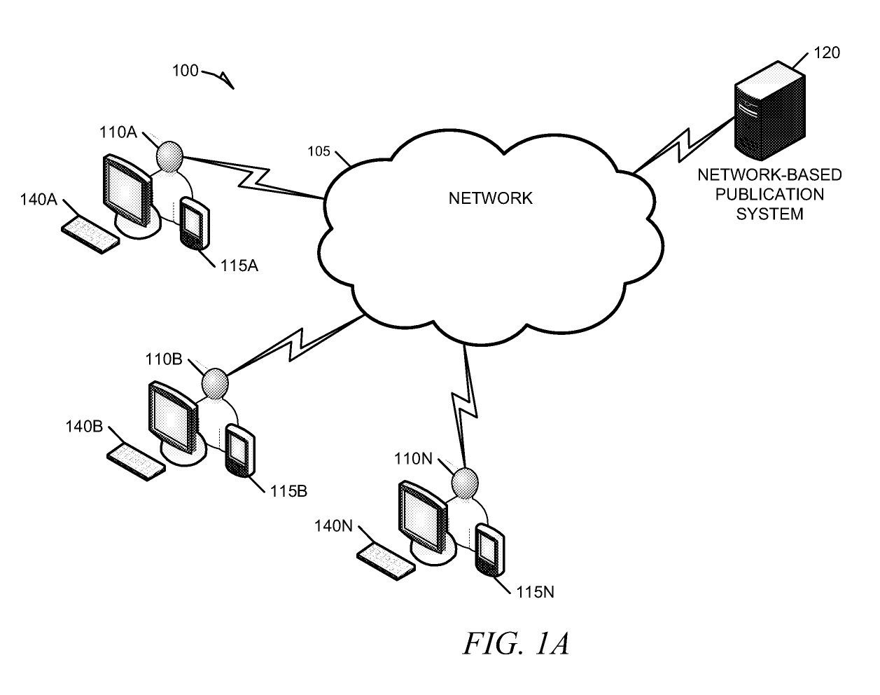

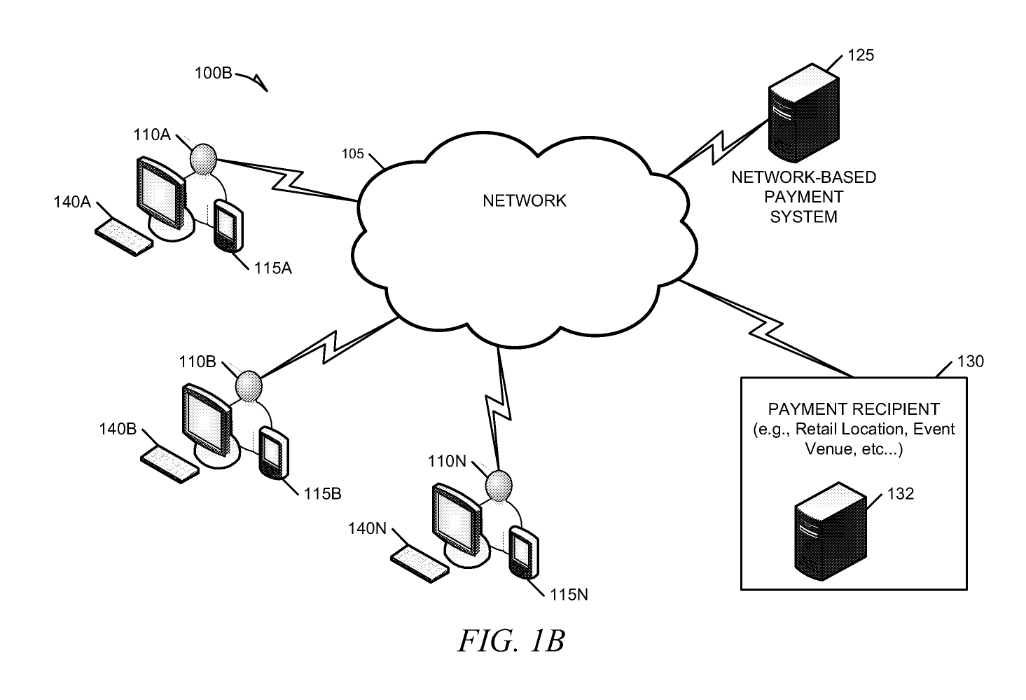

FIG. 1A is a block diagram depicting a system 100 for using group membership in combination with location as an authorization mechanism, according to an example embodiment. In an example, system 100 can include users 110A-110N (collectively referred to as either user 110 or users 110 depending upon context) and a network-based publication system 120. In an example, the users 110A-110N can connect to the network-based publication system 120 via mobile devices 115A-115N (collectively referred to as mobile device 115). Users 110A-110N can also connect to the network-based publication system 120 via clients 140A-140N (collectively referred to as client 140 or clients 140).

In an example, the users 110 can configure a group account on the network-based publication system 120. The group account can be accessed by each user, such as user 110A, using mobile device 115A or client 140A, if user 110A meets the specified access criteria or rules. In an example, the group access rules can include user identification and location identification rules. For example, the group account can include a membership list as well as a target physical location to enable access. Alternatively, the group account can include a rule that requires group member co-location to enable access. For example, the group account can be configured to only enable access when two or more users, such as user 110A and user 110B, are in the same general location (physically proximate to each other). In this example, mobile devices 115A and 115B can include location determination capabilities and can communicate current locations of associated users, such as user 110A and user 110B, respectively to the network-based publication system 120. The network-base publication system 120 can validate that the current locations associated with user 110A and 110B meet the co-location rule associated with the group account prior to granting either user access to the group account.

FIG. 1B is a block diagram depicting a system 100B for using group membership in combination with location as a payment authorization mechanism, according to an example embodiment. In an example, the system 100B can include users 110, a network-based payment system 125, and a payment recipient 130. In an example, the users 110 can use a mobile device 115 or a client 140 to access and communicate with the network-based payment system 125. In certain examples, the users 110 can also communicate with the payment recipient 130. In these examples, the mobile device 115 or the client 140 can communicate with a payment recipient system 132.

Similar to system 100, the payment examples enabled within system 100B can use user identification and location identification as an authorization mechanism to grant access to a group account. In the payment examples, the group account can provide a mechanism for a group of users, such as users 110, to pool financial resources for a specific purchase or particular event, among other things. In an example, a group of users may wish to purchase a particular item from a certain physical location (e.g., a big screen television from a local electronics dealer). In this example, the users 110 may be a group of roommates that have decided to pool money together to purchase a new television. The network-based payment system 125 can enable the users 110 to establish a group payment account with restrictions on where, when, and by whom the pooled money can be spent. The group payment account can be configured with a location restriction (e.g., where) that only allows the pooled funds to be spent at a particular location (or within a certain geographic area, see the geofence concept discussed below). The group payment account can also be configured with a temporal restriction (e.g., when) that will only allow funds to be authorized during a certain approved time frame, such as a certain day. In an example, the group payment account can also be configured to restrict access to the pooled funds to one or more members of the group (e.g., who). In some examples, the group payment account can be configured to restrict access to the pooled funds unless all of the group members are in the target location. Alternatively, the group payment account can be configured without a target location, but require that all members of the group be co-located prior to authorizing a payment. For example, the group payment account discussed above in reference to the television purchase can be configured to allow the group to purchase a television at any retail location, but can require that all members of the group be at the retail location prior to authorization.

In an example, the network-based payment system 125 can enable ad hoc group payment accounts that allow a user, such as user 110A, to invite other users to join a group account for a specific purchase. For example, an ad hoc group payment account can be setup to pay the bill at a restaurant with a group of friends. Each user invited to join the ad hoc group account can agree to a certain funding level or percentage of the overall payment. In the restaurant example, the ad hoc group payment account can be provisioned as a one-time payment account that will dissolve after the restaurant bill has been settled.

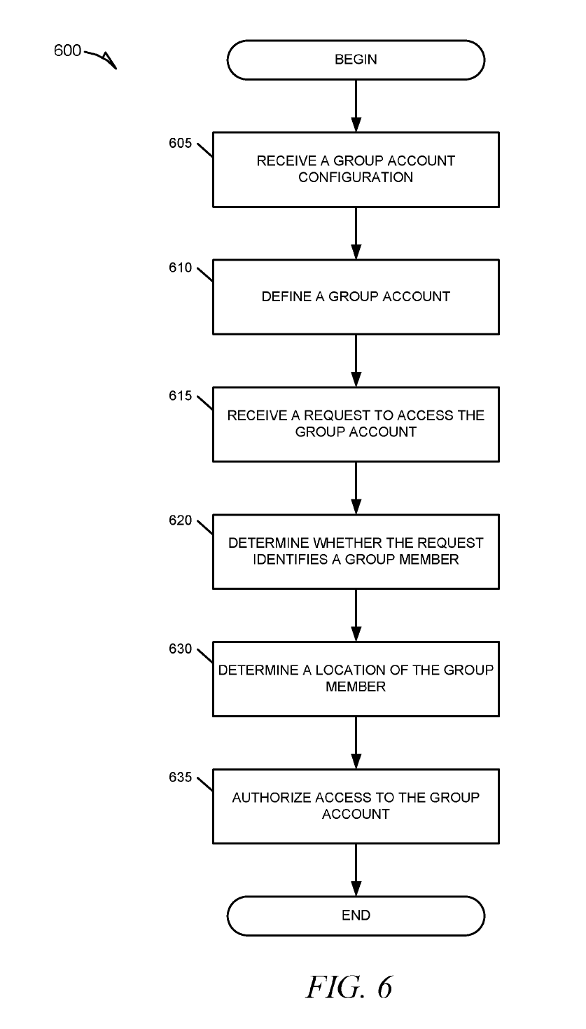

Systems 100 and 100B can enable additional features and functions with respect to various types of group accounts using a co-located group (or group membership and target location) as an authorization mechanism, as discussed below in reference to FIGS. 6-8.

### Example Operating Environment

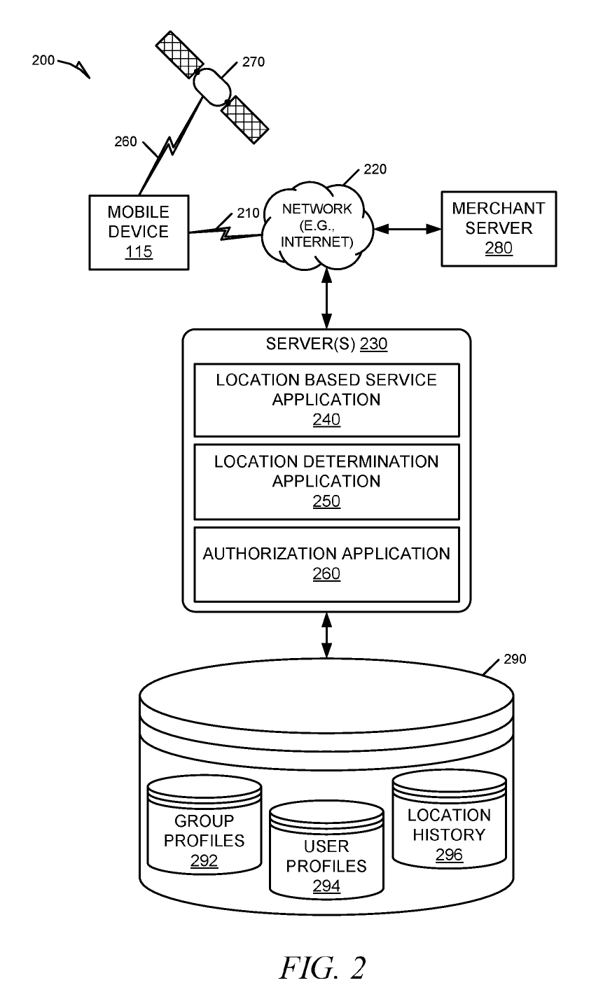

FIG. 2 is a block diagram illustrating an environment 200 for operating a mobile device 115, according to an example embodiment. The environment 200 is an example environment within which methods for using a co-located group of people as an authorization mechanism can be performed. The environment 200 can include a mobile device 115, a communication connection 210, a network 220, servers 230, a communication satellite 270, a merchant server 280, and a database 290. The servers 230 can optionally include location based service application 240, location determination application 250, and publication application 260. The database 290 can optionally include group profiles 292, user profiles 294, and/or location history 296. The mobile device 115 represents one example device that can be utilized by a user to access group accounts or group payment accounts. The mobile device 115 may be any of a variety of types of devices (for example, a cellular telephone, a PDA, a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. For example, one or more servers 230 may execute location based service (LBS) applications 240, which interoperate with software executing on the mobile device 115, to provide LBSs to a user. LBSs can use knowledge of the device's location, and/or the location of other devices, to provide location-specific information, recommendations, notifications, interactive capabilities, and/or other functionality to a user. For example, an LBS application 240 can provide location data to a network-based publication system 120, which can then be used to provide access to a group account on the network-based publication system 120. Knowledge of the device's location, and/or the location of other devices, may be obtained through interoperation of the mobile device 115 with a location determination application 250 executing on one or more of the servers 230. Location information may also be provided by the mobile device 115, without use of a location determination application, such as application 250. In certain examples, the mobile device 115 may have some limited location determination capabilities that are augmented by the location determination application 250. In some examples, the servers 230 can also include authorization application 260 for providing location-aware account access validation. In certain examples, location data can be provided to the authorization application 260 by the location determination application 250. In some examples, the location data provided by the location determination application 250 can include merchant information (e.g., identification of a retail location). In certain examples, the location determination application 250 can receive signals via the network 220 to further identify a location. For example, a merchant may broadcast a specific IEEE 802.11 service set identifier (SSID) that can be interpreted by the location determination application 250 to identify a particular retail location. In another example, the merchant may broadcast an identification signal via radio-frequency identification (RFID), near-field communication (NFC), or a similar protocol that can be used by the location determination application 250. In addition to examples using these various mechanisms to identify a particular location, these mechanisms (e.g., SSIDs, RFIDs, NFC, and so forth) can be used as secondary authentication factors, which are discussed in more detail below.

### Example Mobile Device

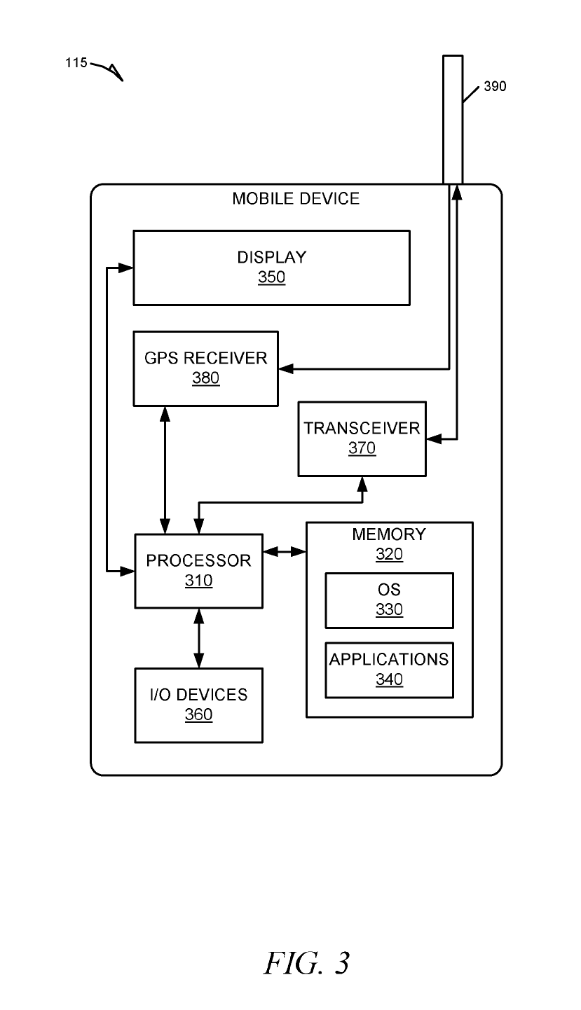

FIG. 3 is a block diagram illustrating the mobile device 115, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor. The memory 320 may be adapted to store an operating system (OS) 330, as well as application programs 340, such as a mobile location enabled application that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 may be established. Further, in some configurations, a GPS receiver 380 may also make use of the antenna 390 to receive GPS signals.

Additional detail regarding providing and receiving location-based services can be found in U.S. Pat. No. 7,848,765, titled “Location-Based Services,” granted to Phillips et al. and assigned to Where, Inc. of Boston, Mass., which is hereby incorporated by reference.

An example geo-location concept discussed within U.S. Pat. No. 7,848,765is a geofence. A geofence can be defined as a perimeter or boundary around a physical location or mobile object (e.g., a user). A geofence can be as simple as a radius around a physical location defining a circular region around the location. However, a geofence can be any geometric shape or an arbitrary boundary drawn on a map. A geofence can be used to determine a geographical area of interest for the calculation of demographics, advertising, or similar purposes. Geofences can be used in conjunction with the offer generation and delivery concepts discussed herein. For example, a geofence can be used to assist in determining whether a user (or mobile device associated with the user) is within a geographic area of interest (e.g., target location) to providing access to a group account. If the user is within a geofence established by provisioning of a group account, the systems discussed herein can use that information to authorize the user to access the group account, such as authorizing the user to process a payment against a group payment account.

### Example Platform Architecture

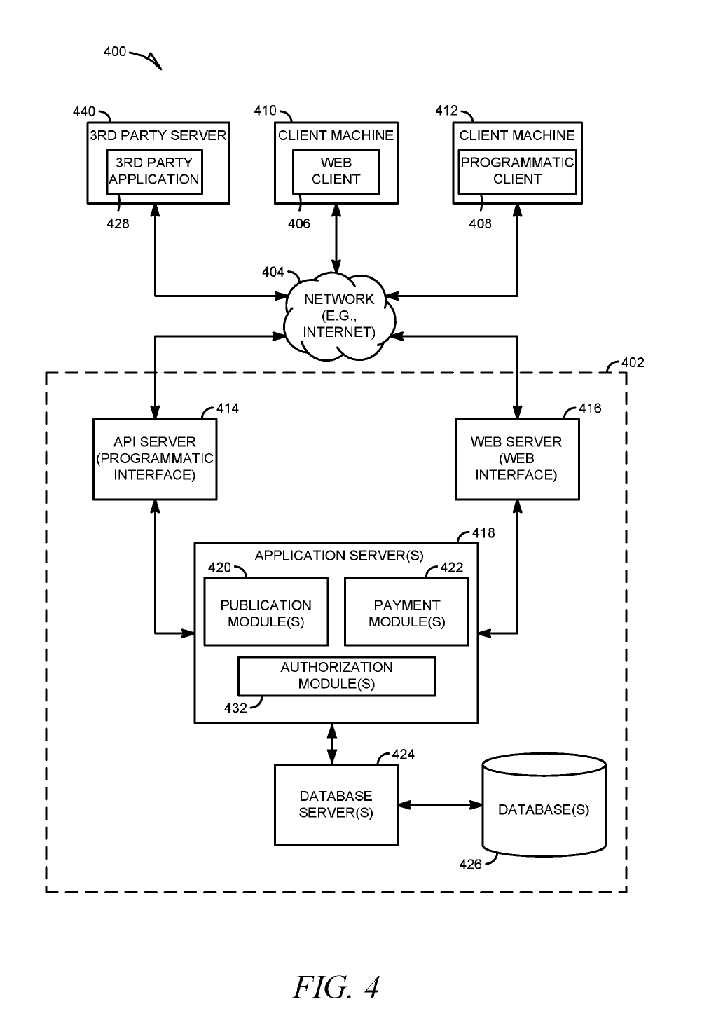

FIG. 4 is a block diagram illustrating a network-based system 400 for using a co-located group as an authorization mechanism, according to an example embodiment. The block diagram depicts a network-based system 400 (in the exemplary form of a client-server system), within which an example embodiment can be deployed. A networked system 402 is shown, in the example form of a network-based location-aware publication or payment system, that provides server-side functionality, via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Wash. State) and a programmatic client 408 (e.g., PAYPAL payments smartphone application from PayPal, Inc. of San Jose Calif.) executing on respective client machines 410 and 412. In an example, the client machines 410 and 412 can be in the form of a mobile device, such as mobile device 115.

An Application Programming Interface (API) server 414 and a web server 416 are coupled to, and provide programmatic and web interfaces respectively to, one or more application servers 418. The application servers 418 host one or more publication modules 420 (in certain examples, these can also include commerce modules, advertising modules, and marketplace modules, to name a few), payment modules 422, and authorization modules 432. The application servers 418 are, in turn, shown to be coupled to one or more database servers 424 that facilitate access to one or more databases 426. In some examples, the application server 418 can access the databases 426 directly without the need for a database server 424.

The publication modules 420 may provide a number of publication functions and services to users that access the networked system 402. The payment modules 422 may likewise provide a number of payment services and functions to users. The payment modules 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues. The payment modules 422 can also be configured to facilitate group payment processing and work in conjunction with the authorization modules 432. The authorization modules 432 may provide authorization rule processing associated with group or individual publication or payment accounts, to name a few. While the publication modules 420, payment modules 422, and authorization modules 432 are shown in FIG. 4 to all form part of the networked system 402, it will be appreciated that, in alternative embodiments, the payment modules 422 may form part of a payment service that is separate and distinct from the networked system 402. Additionally, in some examples, the authorization modules 432 may be part of the payment service or may form an authorization generation service separate and distinct from the networked system 402.

Further, while the system 400 shown in FIG. 4 employs a client-server architecture, the present invention is of course not limited to such an architecture, and could equally well find application in a distributed, or peer-to-peer, architecture system, for example. The various publication modules 420, payment modules 422, and authorization modules 432 could also be implemented as standalone systems or software programs, which do not necessarily have networking capabilities.

The web client 406 accesses the various publication modules 420, payment modules 422, and authorization modules 432 via the web interface supported by the web server 416. Similarly, the programmatic client 408 accesses the various services and functions provided by the publication modules 420, payment modules 422, and authorization modules 432 via the programmatic interface provided by the API server 414. The programmatic client 408 may, for example, be a smartphone application (e.g., the PAYPAL payments application) that enables users to process payments directly from their smartphones leveraging user profile data and current location information provided by the smartphone or accessed over the network 404.

FIG. 4 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide merchants with access to the authorization modules 432 for account validation purposes. In certain examples, the third party server machine 440 may provide group account support and authorization by leveraging the services offered via networked system 402.

### Example Authorization Modules

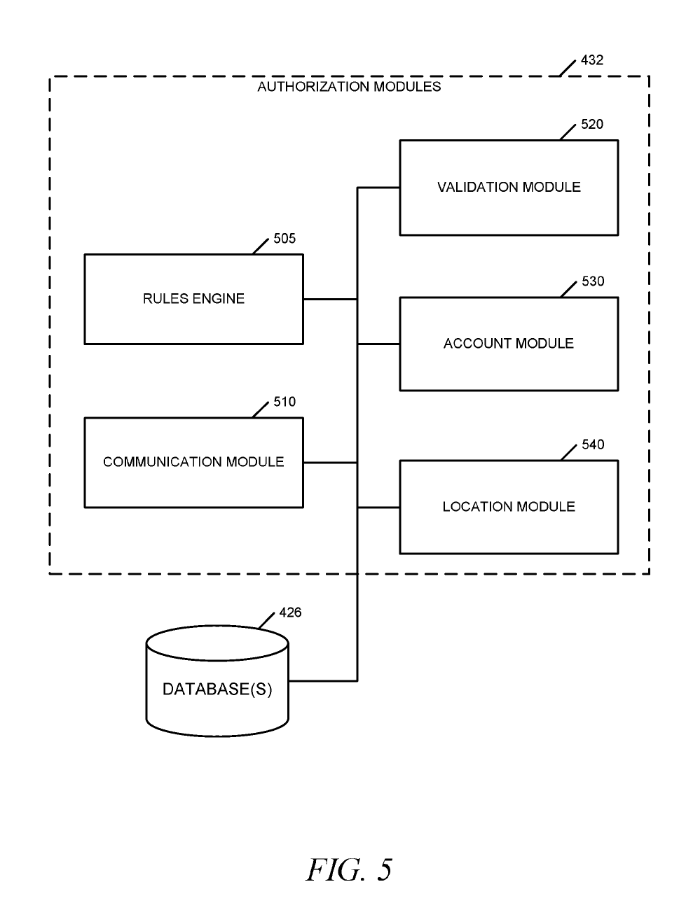

FIG. 5 is a block diagram illustrating authorization modules 432, according to an example embodiment. In this example, the authorization modules 432 can include a rules engine 505, a communication module 510, a validation module 520, an account module 530, and a location module 540. In an example, the authorization modules 432 can access database 426 to store and/or retrieve group account rules, user profile data, and location data, as well as other information, to enable authorization to access group accounts and group payment accounts.

In an example, the rules engine 505 can be configured to manage and evaluate rules controlling access to group accounts. As discussed above, group accounts can be provisioned with a variety of authorization rules. Authorization rules can include location limitations, membership limitations, user identification limitations, temporal limitations, liquidation rules, event lists, funding sources, and social network credentials. The rules engine 505 can work in conjunction with the validation module 520 to validate group account access. The rules engine 505 can also communicate with the communication module 510, the account module 530, and the location module 540, as necessary to evaluate account authorization rules.

In an example, the communication module 510 can be configured to manage communications between the authorization modules 432 and a user, where the user is communicating via the mobile device 115 or the client 140. The communication module 510 can also be configured to manage communications between the authorization modules 432 and a merchant, such as payment recipient 130 communicating via the payment recipient system 132.

In an example, the validation module 520 is configured to authorize access to a group account. The validation module 520 can operate in conjunction with the rules engine 505 to evaluate account authorization rules in reference to a group account access request received by the communication module 510. In an example, the validation module 520 can determine whether a transaction authorization request, associated with a group payment account, properly identifies a user included in the group payment account membership list. The validation module 520 can also authorize a payment against a group payment account if the identified user is proximate to a target location associated with the group payment account.

In an example, the account module 530 is configured to provision (setup) and manage group account on the network-based system 402. In certain examples, the account module can provision a group account according to configuration data received by the communication module 510. The account module 530 can also work in conjunction with the rules engine 505 in provisioning or decommissioning group accounts. For example, the configuration data for a group account can include configuration rules that can be evaluated by the rules engine 505 during the provisioning process. Additionally, the configuration data can also include a set of decommissioning rules that can be evaluated by the rules engine 505 during the decommissioning process. For example, decommissioning rules can include fund distribution, account asset disposition (e.g., electronic data associated with the account), and notifications, among other things.

In an example, the location module 540 is configured to receive location data from a mobile device, such as mobile device 115, and determine from the location data a current physical location, which may include reference to landmarks or other sites of interest. In some examples, the location module 540 can receive GPS-type coordinates (e.g., longitude and latitude), which can be used to establish a current location associated with a mobile device (and, thus, a user of the mobile device). Using the longitude and latitude coordinates, the location module 540 can determine if any physical locations associated with the group account are in proximity to the current location associated with the user. In certain examples, the location module 540 can receive other location determining information from a mobile device, such as a photograph or scan of data only readily available at a certain physical location (generally referred to as secondary location authentication factor). Group accounts can be configured to require an image to be captured that depicts a certain aspect of the physical location. For example, the group account may require that a user requesting access capture and upload a picture of a local landmark (e.g., entrance sign to a theme park or sign for a restaurant). In another example, some merchants may broadcast specific wireless network signals that can be received by a mobile device, such as mobile device 115. Once received, the mobile device 115 can include programming or circuitry to translate the signal into a specific location, or the mobile device 115 can simply retransmit the unique signal to the location module 540. In an example, a merchant location can transmit a unique SSID, which the location module can be programmed to interpret as identifying a specific merchant location. In another example, the merchant may broadcast a unique SSID within all of its locations and the location module 540 can be programmed to use a combination of the unique SSID and other location data (e.g., GPS coordinates or cell tower locations) to identify a specific location. In other examples, the secondary location authentication factor can include any information that can be scanned or input into a mobile device, such as mobile device 115, but is only easily accessible at a specified physical location. Secondary authentication factors can range from pictures of physical attributes to scanning bar codes from a menu to receiving locally unique wireless signals.

Additional details regarding the functionality provided by the location-aware authorization modules 432 are detailed in reference to FIGS. 6-8.

### EXAMPLE Methods

FIG. 6 is a flowchart illustrating a method 600 of enabling a co-located group as an authorization mechanism, according to an example embodiment. In an example, the method 600 can include operations for: receiving a group account configuration at 605, defining a group account at 610, receiving a request to access the group account at 615, determining whether the request identifies a group member at 620, determining a location of the group member at 630, and authorizing access to the group account at 635.

In an example, the method 600 can begin at 605 with the networked system 402 receiving a group account configuration. The group account configuration can include a member list and a target location, among other things. In certain examples, the group account configuration can also include temporal limitations for the group account. For example, the group account configuration can include a list of days that the account will be active and available to group members. At 610, the method 600 can continue with the networked system 402 defining a group account according to the group account configuration. In some examples, as part of the group account provisioning (definition) the network system 402 can send out invitations to users on the membership list included within the group account configuration. The invitations can include a universal resource locator (URL) or similar link that allows a prospective group member, such as user 110B, direct access to register as a group member.

At 615, the method 600 can continue with the networked system 402 receiving a request to access the group account. The request to access the group account can be received from a mobile device, such as mobile device 115, or any client, such as clients 410 or 412, capable of communication with the networked system 402. At 620, the method 600 can continue with the networked system 402 determining whether the request identifies a group member. In an example, the networked system 402 receives credentials from a mobile device, such as mobile device 115, matching the credentials registered when the user, such as user 110, registered as a member of the group account. In another example, the networked system 402 can use an identifier associated with the mobile device 115 that is registered with a service provider, such as a wireless service provider, to identify a group member.

At 630, the method 600 can continue with the networked system 402 determining a location of the identified group member. In an example, the networked system 402 can also verify that the identified group member is in proximity to the target location defined within the group account configuration. In certain examples, the method 600 can also determine the location of other group members to determine whether two of more of the group members are in proximity to one another (e.g., co-located).

At 635, the method 600 can conclude with the networked system 402 authorizing access to the group account based on the access request. In an example, the networked system 402 validates group membership and location information prior to granting access. In certain examples, the networked system 402 can validate that two or more members of the group are co-located prior to granting access to the account. In some examples, the group account configuration can include a requirement for, and definition of, a secondary authorization factor. The secondary authorization factor can be a code or PIN, a picture, or any locally unique information that can be scanned or otherwise input into the mobile device 115 or client 410, 412. In certain examples, the mobile device 115 can include a camera and/or bar code scanner to facilitate obtaining information to satisfy the secondary authorization factor.

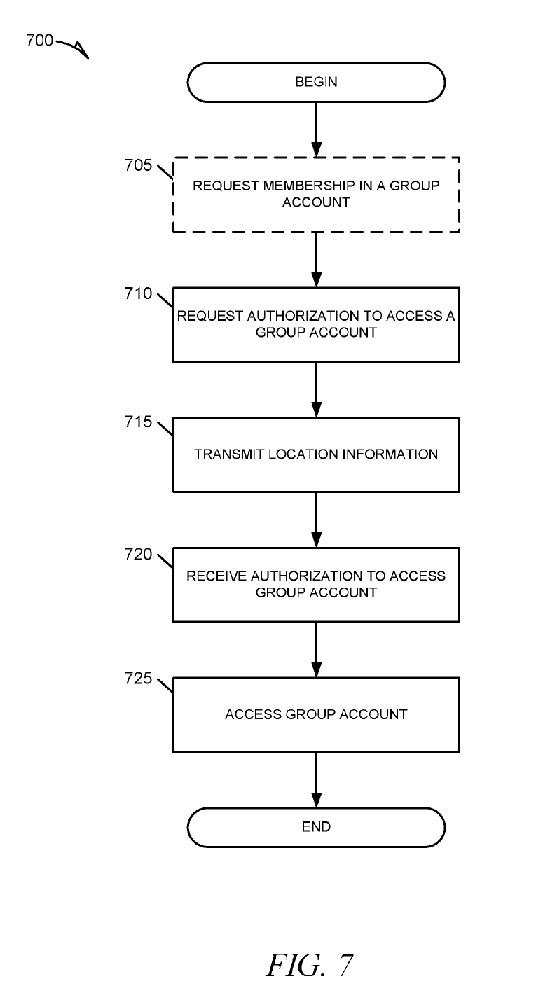

FIG. 7 is a flowchart illustrating a method 700 of using group membership in combination with location information as an authorization mechanism, according to an example embodiment. In an example, the method 700 can include operations for: optionally requesting membership in a group account at 705, requesting authorization to access a group account at 710, transmitting location information at 715, receiving authorization to access the group account at 720, and accessing the group account at 725. In an example, the operations discussed in reference to method 700 can be performed on the mobile device 115, the client 410, the client 412, or another suitable client device capable of communicating over a network, such as the Internet.

At 705, the method 700 can optionally begin with the mobile device 115 sending a request for membership in a group account. In an example, the request for membership sent by the mobile device 115 can be in response to an invitation received by the mobile device 115. At 710, the method 700 can continue with the mobile device 115 requesting authorization to access the group account. In an example, the mobile device 115 can be requesting access to a social network oriented group account, such as a photo sharing site. In another example, the mobile device 115 can be requesting access to a group payment account. In some examples, the request to access the group account can include identification information, such as information necessary for the networked system 402 to identify a user, such as user 110. In these examples, the request for group account access can also include location information identifying a current geographical location associated with the mobile device 115 and by association a user. In certain examples, the request for authorization to access a group account can also include a secondary authentication factor, such as a PIN code or image taken at a certain location. In examples involving a group payment account, the request for authorization to access the group payment account can include a source of funds associated with the user of the mobile device 115, such as user 110.

At 715, the method 700 continues with the mobile device 115 transmitting location information identifying a current location of the mobile device 115. In certain examples, the location information can be transmitted in conjunction with the request for authorization in operation 710. At 720, the method 700 can continue with the mobile device 115 receiving authorization to access the group account. In an example, the authorization can include credentials to be used by the mobile device 115 to access the group account. The credentials can be one-time use credentials or can allow continued access for the duration of the existence of the group account. At 725, the method 700 can conclude with the mobile device 115 accessing the group account. In an example, the mobile device 115 can use the credentials received in the authorization to access the group account.

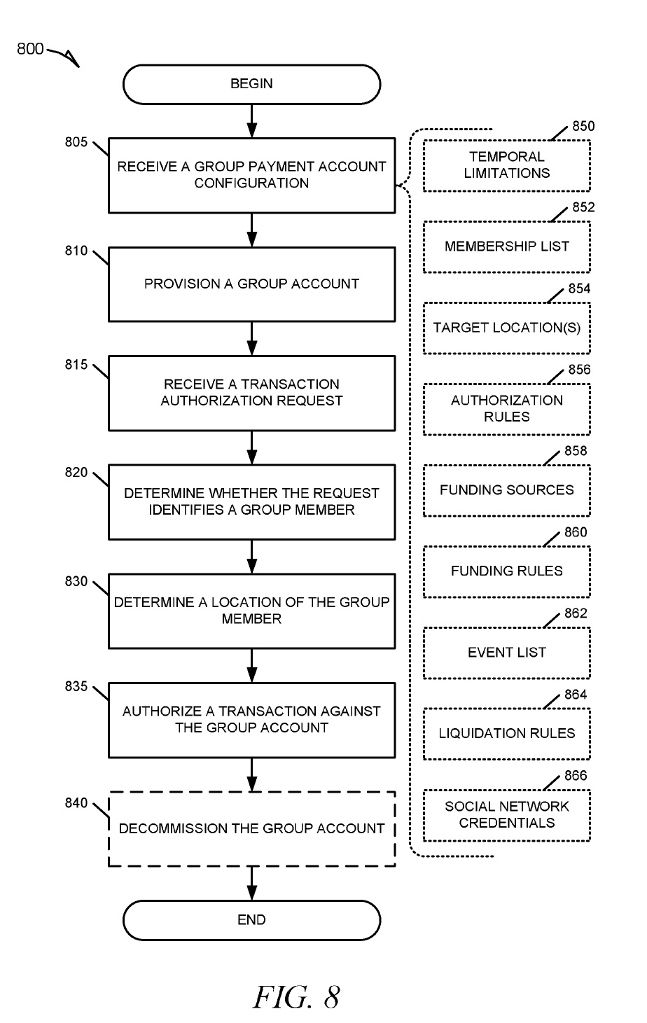

FIG. 8 is a flowchart illustrating a method 800 of using group membership in combination with location information as a payment authorization mechanism, according to an example embodiment. In an example, the method 800 can include operations for: receiving a group payment account configuration at 805, provisioning a group account at 810, receiving a transaction authorization request at 815, determining whether the request identifies a group member at 820; determining a location of the identified group member at 830; authorizing a transaction against the group payment account at 835, and optionally decommissioning the group payment account at 840. In an example, the group payment account configuration can optionally include information such as: temporal limitations (850), membership list (852), target location data (854), authorization rules (856), funding sources (858), funding rules (860), event list (862), liquidation rules (864), and social network credentials (866), among others.

In an example, the method 800 can begin at 805 with the networked system 402 receiving a group payment account configuration. The group payment account configuration can include various combinations of the data items represented by elements 850 through 866. At 810, the method 800 can continue with the networked system 402 using the group payment account configuration information to provision a group payment account. In an example, the group payment account can include a membership list to identify users that are authorized to access the group payment account and process payments against the group payment account. The group payment account can also include a target location that restricts authorization to process payments against the account to users in proximity to the target location. The group payment account can also include authorization rules that further restrict access to funds within the group payment account. For example, the authorization rules can include a funding threshold. If a payment request exceeds the funding threshold additional authorization can be required (e.g., authorization from additional group members or from a master account holder member).

In certain examples, the group payment account can maintain a list of funding sources used to draw funds into the group payment account. The funding sources can each include funding limits. The funding limits can be hard exact dollar amount limits or can be a percentage of overall funding requirements for the group payment account. For example, a first funding source associated with user 110A can be configured with a specific limit of $500, while a second funding source associated with user 110B can be configured to allow for 10% of all funds approved and spent by the group payment account to be sourced from the second funding source. A funding source can include any financial instrument, such as a bank account or credit card. Funding limitations associated with the specific financial instrument can also be tracked and observed by the group payment account. In addition to the funding sources and related limitations, the group payment account can also include funding rules. Funding rules can manage when funds are drawn from particular funding sources. For example, a funding rule can allow for the first $200 of funds to be drawn from a specific funding source.

At 815, the method 800 can continue with the networked system 402 receiving a transaction authorization request to process a transaction against the group payment account. At 820, the method 800 can continue with the networked system 402 determining whether the request identifies a member of the group payment account. At 830, the method 800 can continue with the networked system 402 determining a location associated with the identified group member. At 835, the method 800 can continue with the networked system 402 authorizing the transaction to be processed against the group payment account. In an example, the networked system 402 validates that the group membership and location corresponds to the requirements set forth in the group payment account configuration. In certain examples, the networked system 402 also validates that the requested payment amount does not exceed a specified threshold. If the requested payment amount does exceed a specified threshold, the networked system 402 can communicate with other group members to obtain secondary authorization. In some examples, the networked system 402 can also validate that the authorization request falls within an allowable timeframe for approval against the group payment account. The allowable timeframe can be validated against the temporal limitations (850) received with the group payment account configuration.

Finally, at 840, the method 800 can optionally conclude with the networked system 402 decommissioning (also referred to as liquidating) the group payment account. In an example, the networked system 402 can decommission the group payment account according to the liquidation rules (864) received within the group payment account configuration. The liquidation rules (864) can include rules to govern dispersing any remaining funds in the group payment account or settlement of any outstanding debts incurred by the group payment account.

In certain examples, the method 800 can support ad hoc group payment accounts that exist solely to settle a particular debt, such as a restaurant bill. In the ad hoc group payment account example, at 810 the method 800 can include the networked system 402 sending out invitations to potential group members to join the group payment account. The provisioning operation at 810 can also include receiving responses from the invitations, which can include a funding source and funding amount (or contribution amount) for each group member.

In the ad hoc example, the receiving the transaction authorization request operation at 815 can extract the authorization request from the group payment account configuration as the group payment account is being established solely to settle a specific transaction. In this example, the temporal limitations (850) can be within the next X minutes to further limit the applicability of the ad hoc group payment account. Limiting the ad hoc group payment account to settlement of a particular transaction, at a particular location, and within a particular limited timeframe may provide users an extra level of comfort that access to a financial instruction will not be abused. In this example, the remaining operations within method 800 can occur as described above.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of these. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

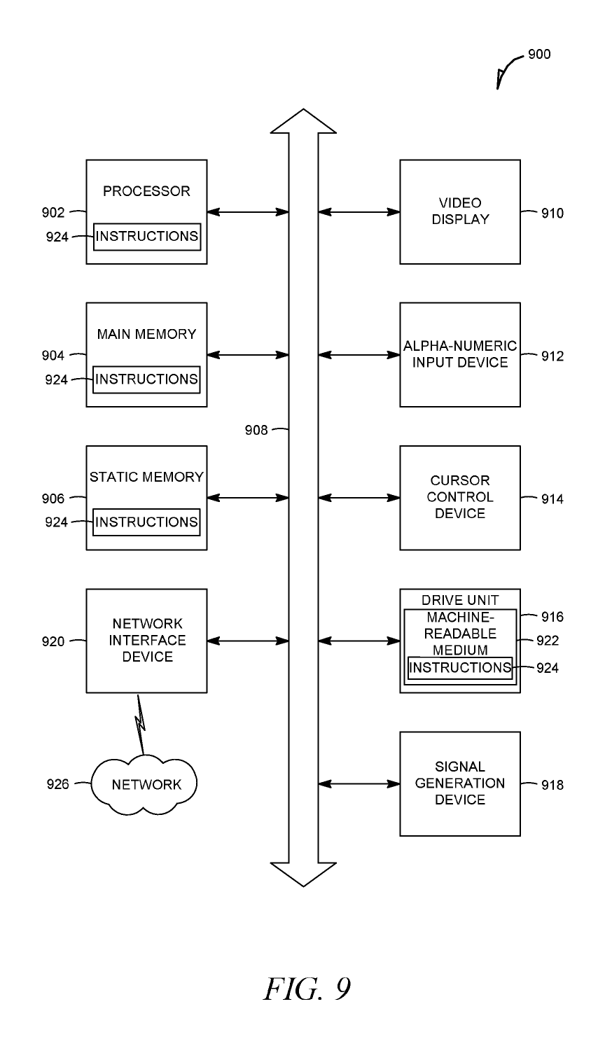

FIG. 9 is a block diagram of a machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control (user interface (UI) navigation) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, with the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for making contextual recommendations to users on a network-based marketplace have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
establishing, using one or more processors operating within a network-based system, a group account, the group account defining a membership list including at least one member and an authorized location;
receiving, from a mobile device associated with a member using the one or more processors, a request to access the group account, the request including at least a member identifier and a current location of the mobile device;
determining, using the one or more processors, whether the member identifier matches a member on the membership list;
determining, using the one or more processors, whether the current location associated is within a pre-defined distance of the authorized location; and
authorizing, using the one or more processors, the request to access the group account based at least in part on determining that the member identifier matches a member on the membership list and determining that the current location is within the pre-defined distance of the authorized location.

2. The method of claim 1, wherein the establishing the group account includes setting a time period limitation associated with the group account; and
wherein the authorizing the request to access the group account includes validating tha the request was received within the time period limitation.

3. The method of claim 2, wherein the time period limitation includes a list of dates when the group account is available to members included on the membership list.

4. The method of claim 1, wherein receiving the request to access the group account includes receiving a requested operation; and
wherein the authorizing the request includes validating that the requested operation does not violate any authorization rules associated with the group account.

5. (canceled)

6. The method of claim 1, wherein the authorizing the request to access the group account includes verifying a secondary authentication factor.

7. The method of claim 6, wherein the verifying the secondary authentication factor includes receiving and verifying at least one of the following secondary authentication factors:
a password;
a picture of a landmark associated with the authorized location; and
a code readily available only at the authorized location and scanned with the mobile device associated with the identified user.

8. The method of claim 1, wherein the receiving the request to access the group account includes a payment request, the payment request to be satisfied by one or more funding sources associated with the group account.

9. The method of claim 1, wherein the authorizing the request to access the group account includes determining that a pre-defined number of members on the membership list arc within a pre-defined distance of the authorized location.

10. A system comprising:
a server coupled to a network to enable communication with a mobile device associated with a member, the server including:
an account module configured to provision a group account according a group account configuration, the group account configuration including a membership list including at least one member and an authorized location associated with the group account;
a communication module configured to receive, from the mobile device associated with a member over the network, a request to access the group account hosted on the server, the request including at least a member identifier identifying the member associated with the mobile device and a current location associated with the mobile device;
a location module configured to determine whether the current location is within a pre-defined distance of the authorized location;
a validation module configured to,
determine whether the member identifier matches a member on the membership list, and
authorize the request to access the group account based at least in part on determining that the member identifier matches a member on the membership list and determining that the current location is within the pre-defined distance of the authorized location.

11. The system of claim 10, wherein the account module is further configured to generate a time period limitation associated with the group account; and
wherein the validation module is further configured to verify that the request was received within the time period limitation prior to authorizing the request.

12. The system of claim 11, wherein account module generates a list of dates as the time period limitation, the list of dates representing a time period when members on the membership list can access the group account.

13. The system of claim 10, wherein the communication module is further configured to receive a requested operation with the request to access the group account; and
wherein the validation module is further configured to validate that the requested operation does not violate any authorization rules associated with the group account.

14. The system of claim 10, wherein the validation module is further configured to verify a secondary authentication factor prior to authorizing the request to access the group account.

15. The system of claim 14, wherein the validation module is configured to verify at least one of the following secondary authentication factors:
a password;
a picture of a landmark associated with the authorized location; and
a code readily available only at the authorized location and scanned with the mobile device.

16. The system of claim 10, wherein the communication module is further configured to receive a payment request as part of the request to access the group account; and
wherein the validation module is further configured to validate the payment request against one or more funding sources associated with the group account.

17. The system of claim 10, wherein the validation module is further configured to verify that a predetermined number of members on the membership list are within the pre-defined distance of the authorized location prior to authorizing the request to access the group account.

18. A non-transitory machine-readable storage medium containing instructions that, when executed by a machine, cause the machine to:
establish, on a network-based system, a group account, the group account defining a membership list including at least one member and an authorized location;
receive, from a mobile device associated with a member, a request to access the group account, the request including at least a member identifier and a current location of the mobile device,
determine whether the member identifier matches a member on the membership list;
determine whether the current location associated with the member identifier is within a pre-defined distance of the authorized location; and
authorize the request to access the group account based at least in part on determining that the member identifier matches a member on the membership list and determining that the current location is within the pre-defined distance of the authorized location.

19. The non-transition machine-readable storage medium of claim 18, wherein the instructions that cause the machine to establish the group account include instructions that cause the machine to set a time period limitation associated with the group account; and
wherein the instructions that cause the machine to authorize the request to access the group account include instructions that cause the machine to validate that the request was received within the time period limitation.

20. The non-transitory machine-readable storage medium of claim 18, wherein the instructions that cause the machine to receive the request to access the group account include instructions that cause the machine to receive a payment request associated with the request, the payment request to be satisfied by one or more funding sources associated with the group account.
